(19) United States
(12) Patent Application Publication
(10) Pub. No.: US 2018/0229974 A1
(43) Pub. Date: Aug. 16, 2018

(54) Fabricated Plate Hook

(71) Applicant: Mazzella Lifting Technologies, Inc., Cleveland, OH (US)

(72) Inventors: Dan Sherwood, Bay Village, OH (US); Clyde Shetler, Marblehead, OH (US); Liliana Radu, Anthem, AZ (US)

(21) Appl. No.: 15/893,936

(22) Filed: Feb. 12, 2018

Related U.S. Application Data
(60) Provisional application No. 62/457,446, filed on Feb. 10, 2017.

(51) Int. Cl. B66C 1/34; B66C 1/14

(52) U.S. Cl. CPC B66C 1/34; B66C 1/14

(57) ABSTRACT

A plate lifting hook which is capable of being used across a number of varying industries, ranging from large-scale industrial use to that of small-scale personal use. The plate lifting hook retains the structural stability associated with other hooks of a similar capacity, while substantially decreasing the overall weight of the hook. The plate lifting hook is capable of being manufactured from a lesser amount of material while retaining the capability of supporting the same loads as that of similar lifting hooks. The process of fabricating the plate lifting hook may comprise the use of lower alloy materials, in the absence of further heat treatment, affixed to a supporting structure so as to sufficiently support the required load.

### TECHNICAL FIELD

A device to assist in the lifting of various materials, namely in the field of connection devices which include lifting hooks and other similar devices. The device may be secured to a wide variety of different lifting mechanisms such that the device is capable of securely transporting the desired materials. The present invention is suitable for applications ranging from large scale industrial lifting of heavy objects to that of smaller-scale lifting of lighter objects. The device may be used for the lifting of objects such that they may be moved, transported, redistributed, or for any other purpose which may require the moving of objects in such a manner.

### BACKGROUND

In many industrial settings, there exists a need to be able to readily lift and transport a large quantity of materials quickly and efficiently. One of the common materials which is the subject of such transportation is that of plates (often times steel plates). A common device used for the transport of such steel plates is what is known in the field as a plate hook. The general premise of such a plate hook is that it may be affixed to a lifting device such that the plates may be lifted and manipulated by the user of the lifting device.

The standard plate hook has undergone a number of transformations over the years. Amidst these transformations, a number of common principles have endured which help to define the plate hook as the preferred method for transporting steel plates. Among these principles are the means to be affixed to a lifting device. However, as the industrial setting in which such plate hooks are typically used is always undergoing various changes, the lifting devices which are commonly associated with such lifting hooks are also the subject of constant change. In order to be reactive to such changes in the industry, the means for affixing a plate hook to the lifting device must therefore be able to adapt to any different number of lifting devices.

Another principle of the plate hook which has generally endured over time is the general “hook-like” shape. In order to allow for a plate hook to grasp a plate, the plate hook typically employs at least two distinct faces which are able to contact the plate. Variations which have been implemented over the years include alteration of the angle formed by the faces, the addition of contact faces or surfaces with which the plate is able to contact, and the materials out of which the hook is generally constructed. However, the general structure of a plate lifting hook, which has been found to be extremely successful for its designed purpose, has also brought with it a number of obstacles which have been difficult to overcome.

One of the primary obstacles associated with present lifting hooks is their size and weight. Due to the need for supporting large, and often times extremely heavy loads, many plate hooks result in a design that is quite large and bulky. Such a construction results in difficult use for those tasked with operating the plate hook. One such problem may be seen by those workers who are tasked with fixing the lifting hook to the lifting device. Such a large and heavy hook may prove difficult, and often times dangerous, for such personnel.

Another similar problem posed by the size and weight of common lifting hooks is that they may prove difficult to control for the operator of the lifting device. The weight of the lifting hook may prove difficult to control, thus resulting in hazardous conditions of such a lifting hook being placed overhead of other workers. To compound such a hazard, when the hook has been engaged with a steel plate, the danger increases exponentially. What was already viewed as a potentially unstable and difficult to control piece of equipment is now engaged with a large steel plate which may only create a more difficult situation for the operator and those others involved.

There has yet to be a lifting hook which is capable of addressing and alleviating the obstacles discussed above. While there have been hooks which seek to address the issue of size and weight, such ideas have shown to result in decreased structural stability of the lifting hook itself. Such an issue creates conditions even more hazardous than those proposed by a heavy and sometimes difficult to control lifting hook. When the structural soundness of the lifting hook itself is sacrificed in order to create a more “user-friendly” device, such a device should be seen as a hindrance, rather than improvement, to the present field of endeavor.

While different methods of forming or fabricating plate lifting hooks are known and used in the industry, one of the more frequently used and well known of such fabrication techniques involves the manufacture of the plate lifting hook from a high alloy material. Such a high alloy material may be cold formed into the desired shape and structure so as to form the desired plate lifting hook. Once formed by this process, the high alloy is heat treated. Such a process of cold forming with subsequent heat treatment is readily known in the art and requires no further elaboration in the present disclosure. Another fabrication technique which is commonly used is that which involves the high alloy material being hot formed, commonly referred to as forged, into the desired shape and structure so as to form the desired plate lifting hook. Such a process of forging alloys is readily known in the art and requires no further elaboration in the present disclosure. The high alloy material from which current plate lifting hooks are often fabricated may possess chemical properties which, when the plate lifting hook is subjected to heat treatment, result in the alteration of the properties of the high alloy material. Whether being formed by cold forming or forging, such plate lifting hooks which are fabricated from high alloy material must therefore be subjected to heat treatment so as to obtain ultimate, or desired, properties relating to strength. Upon being heat treated, these plate lifting hooks may thus obtain properties which are of a stronger nature than those possessed by a similar hook made of high alloy material which has not undergone similar heat treatment procedures, or those hooks which are solely fabricated from primarily low alloy materials, with no additional structural support, regardless of whether they have been subjected to subsequent heat treatment. Those properties which are increased may include tensile strength, shear strength, lifting strength, or any other properties which are susceptible to an increase in strength as a result of heat treatment.

What is further needed in the art is a new method of fabricating such plate lifting hooks in a more economic and efficient way. Such a new method of fabrication must be capable of retaining the necessary strength properties associated with the stress to which the plate lifting hook will be subjected to during use, while also addressing those issues herein mentioned.

The present invention is intended to address and satisfy those concerns listed above; a lifting hook which is capable of wide-scale versatility with regards to use and application, while retaining the structural stability and soundness which is required of industrial plate lifting hooks. The present invention may further be capable of being manufactured from a new method of fabrication which is able to reduce any number of costs associated with the production thereof, while retaining such structural properties herein referenced.

### SUMMARY

The present invention is a device which is capable of lifting steel plates. The lifting hook may be characterized by its ability to be affixed to a large variety of different lifting devices. The versatility associated with the lifting hook thus allows for the lifting hook to be used for a number of different applications. One such application of use is that of an industrial setting in which the lifting hook is capable of transporting large, heavy steel plates about a specified location of travel. However, the lifting hook of the present invention is not limited to such large scale use. Due to the versatility in attachment means, the present invention may also be adapted for smaller-scale use.

A lifting hook which is able to reduce the size and weight thereof may impact the industry of plate lifting and transportation in a number of ways, including operational safety and efficiency. The present invention is a means for significantly decreasing the overall weight of a plate lifting hook such that when attached to a lifting device, a user may have greater control and stability over the lifting hook. While the weight of the lifting hook has been drastically decreased, the overall structural soundness and stability of the lifting hook is retained such that the lifting hook is still capable of lifting and transporting those loads which are associated with similar lifting hooks in the industry.

### BRIEF DESCRIPTION OF THE DRAWINGS

The accompanying drawings in the following description illustrate various embodiments of the present disclosure.

FIG. 1 is a side view of the plate lifting hook.

FIG. 2 is a side view of the plate lifting hook showing various length and width dimensions thereof.

FIG. 3 is a side view of the plate lifting hook showing various angle and thickness dimensions thereof.

FIG. 4 is a view of the back side of the plate lifting hook.

FIG. 5 is a view of the back side of the plate lifting hook showing various dimensions and features thereof.

FIG. 6 is a side view of an embodiment of the plate lifting hook being affixed to a particular external lifting device.

### DETAILED DESCRIPTION

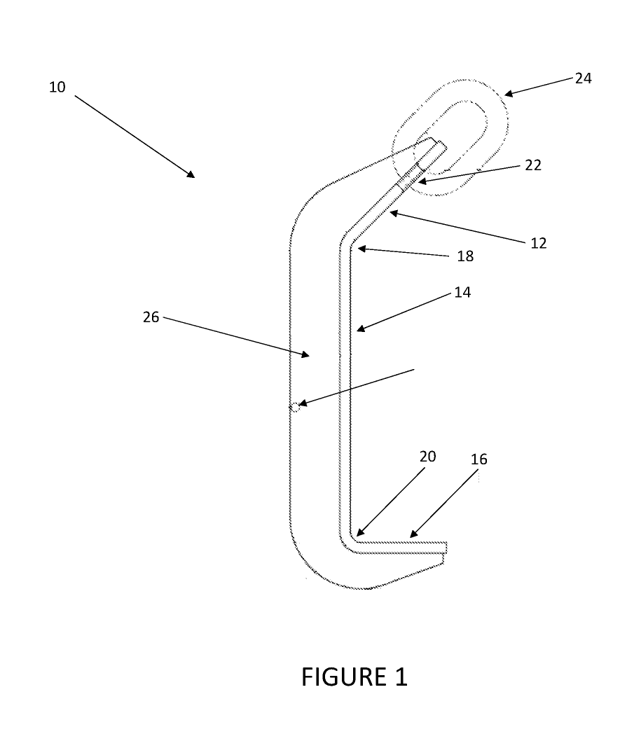

With reference to FIG. 1, the plate lifting hook 10 may be seen. The plate lifting hook 10 consists of at least three distinct surfaces: a connecting surface 12, a backing surface 14, and a supporting surface 16. The connecting surface 12 is defined by the ability to affix or attach the plate lifting hook 10 to an external lifting device. The backing surface 14 is defined in that it provides the structural support to the plate lifting hook 10. The supporting surface 16 is defined by its ability to support the load which is to be transported by the plate lifting hook 10.

With continued reference to FIG. 1, the backing surface 14 is located between that of the connecting surface 12 and the supporting surface 16. The connecting surface 12 and the supporting surface 16 are thereby located on opposing ends of the backing surface 14. According to an embodiment of the present invention, each of the three surfaces are a distinct feature which are thereby connected to one another by way of a connecting means. The means of connecting the surfaces to one another may include any such manner of attaching the multiple surfaces to one another, such as welding, adhesive, clamping, or any other suitable means recognized by one having ordinary skill in the art which allows the plate lifting hook 10 to retain the requisite amount of structural integrity.

According to an alternative embodiment of the present invention, the various surfaces of the plate lifting hook 10 are constructed from a singular piece of material and molded into the desired design. According to this embodiment, each of the respective surfaces are thus defined by their relation to one another and general purpose in carrying out the function of the present invention, as previously described. The distinct surfaces may further be distinguished from one another by way of the angular orientation with respect to that of the backing surface 14. When in use, the backing surface 14 is typically placed in a substantially vertical position. The remaining two surfaces may thereby be defined by their position and location with respect to the vertical orientation of the backing surface 14. According to one such embodiment, each of the connecting surface 12 and support surface 16 are oriented perpendicular, or substantially perpendicular, to that of the backing surface 14.

The plate lifting hook 10 may be constructed of any material identified by those skilled in the relevant art as being able to adequately support the weight of the loads to be transported. Such materials may include, but are not limited to, steel, fabricated alloy steel, various alloy compounds, or durable plastic or polymer compounds. Any of the respective surfaces may further be coated or lined with additional materials or compounds such that the marring or scratching effects of such contact surfaces on the load which is to be lifted or transported are diminished or eliminated.

The plate lifting hook 10 of the present invention may be manufactured from any of the known fabricating methods or techniques which are commonly known and used in the art. According to a further embodiment of the present invention, the plate lifting hook 10 may be partially fabricated from a lower alloy material. When using such a lower alloy material, parts of the plate lifting hook 10 may be cold formed. Such a process of cold forming may be used for any of the contact surfaces of the plate lifting hook 10. The contact surfaces may be defined as those surfaces which are responsible for, or capable of, coming into contact with the load to be lifted during normal operation of the plate lifting hook 10 when being used for its designed purpose. With regard to FIG. 1, the contact surfaces are comprised of the connecting surface 12, backing surface 14, and supporting surface 16. Fabricating the contact surfaces from a lower alloy material results in a plate lifting hook 10 which is of a desired shape and structure. The contact surfaces of the plate lifting hook 10 of the present embodiment are not subjected to any further heat treatment. The critical properties of such a lower alloy material alone, in the absence of heat treatment, are generally lower as compared to lifting hooks which are fabricated from high alloy materials and subsequently subjected to heat treatment.

The addition of the at least one support wing 26, which may be affixed to the contact surfaces, overcomes any deficiency inherent in the lower alloy materials, thus raising the structural strength of the present invention to equal or exceed that of a heat treated counterpart. The support wing 26 is affixed to the reverse side of the contact surfaces which are responsible for making contact with the load to be lifted. The support wing 26 is thus fabricated from a high strength alloy or other material capable of overcoming the deficiency in lifting strength associated with the contact surfaces which are fabricated by way of cold forming in the absence of subsequent heat treatment. One possible means of affixing the support wing 26 to the reverse side of the contact surfaces is by way of welding. According to further embodiments of the present invention, attachment of the support wing 26 to the reverse side of the contact surfaces may be by any means identified by those having skill in the art which are capable of supplying a sufficiently strong structural attachment between the surfaces. The plate lifting hook 10 which is comprised of the support wing 26 affixed to the reverse side of the contact surfaces is thus capable of lifting equivalent loads as compared to that of comparable lifting hooks comprised solely of high alloy material in the absence of a supporting wing or other structure.

According to one embodiment, the three surfaces of the plate lifting hook 10 are arranged in a generally C-shaped hook design, as is well known in the relevant art. Such a C hook may be defined by orienting the plate lifting hook 10 such that the backing surface 14 is in a substantially vertical position, as is customary when the device is in use. With reference to the backing surface 14, each of the connecting surface 12 and supporting surface 16 may extend, from opposing ends of the backing surface 14, in the same direction. Such a direction may be perpendicular with regard to the backing surface 14, substantially perpendicular to that of the backing surface 14, substantially in the same directional vector as that of the backing surface 14, in the same directional vector as that of the backing surface 14, or at any other angle located somewhere between 0-180° with respect to that of the backing surface 14. Each of the connecting surface 12 and supporting surface 16 may extend away from the backing surface 14 at a unique angle, independent from that of one another.

Returning now to FIG. 1, the generally C-shaped structure of the plate lifting hook 10 may be seen. According to this embodiment of the present invention, the connecting surface 12 extends away from the backing surface 14 at a first angle 18 which is obtuse with reference to the backing surface 14. The supporting surface 16 extends away from the backing surface 14 in a manner which is perpendicular to, or substantially perpendicular to, that of the direction of the backing surface 14. Such a perpendicular, or substantially perpendicular, orientation creates a second angle 20 which is 90°, or substantially 90°, with regard to the backing surface 14.

With continued reference to FIG. 1, the general C-shaped structure of the plate lifting hook 10 may incorporate the use of various angles for which each of the respective connecting surface 12 and supporting surface 16 are oriented with regard to the backing surface 14.

The connecting surface 12, being defined by the ability to attach or affix the plate lifting hook 10 to an external lifting device, may have located somewhere about its surface a means for attaching or affixing thereto. Such a means of attachment may be by any manner as is recognized by those skilled in the art for securely and adequately affixing a plate lifting hook to an external lifting device. One such means may be by way of an insert or cutout portion which allows for a corresponding component of an external lifting device to be inserted or affixed thereto. Other means of attachment may include, but are not limited to, the use of magnetic forces, adhesive, clamping devices, or any other suitable means as identified by one having skill in the art.

With reference to FIG. 1, the means for attaching the plate lifting hook 10 to that of an external lifting device is by way of a channel 22 located about the connecting surface 12. The channel 22 consists of a cutout portion about the connecting surface 12 such that an object may be inserted entirely through said cutout portion. Such a channel 22 may be circular, rectangular, square, or of any other geometric dimensions and proportions, so long as the channel 22 is of a sufficient size so as to allow passage of the necessary corresponding component of the external lifting device to be affixed or attached thereto.

A necessary corresponding component of the external lifting device may be any such component which is capable of attaching the plate lifting hook 10 to that of the external lifting device. With regard to FIG. 1, the necessary corresponding component of the external lifting device is that of a chain sling 24. Any other similar components which are commonly used in the field, or identified by those having skill in the art, may be used for purposes of affixing or attaching the plate lifting hook 10 to the external lifting device.

With continued reference to FIG. 1, the plate lifting hook 10 may further comprise at least one secondary feature for the purpose of adding additional structural support thereto. Such a secondary feature of structural support may be an additional surface which extends away from that of the surfaces which are used to contact the material which is to be lifted. Support wing 26 is but one example of such a secondary feature of structural support. Support wing 26 extends away from that of the contact surface of each of connecting surface 12, backing surface 14, and supporting surface 16. Support wing 26 may thus be constructed of the same material as that of the aforementioned surfaces, or of any other material which is capable of providing the adequate amount of secondary support necessary for supporting the load which is to be lifted, as identified by those having skill in the art.

According to one embodiment, support wing 26 is constructed of a single component which is capable of following along, and is thus affixed to, the contours of each of the connecting surface 12, backing surface 14, and supporting surface 16. Such an embodiment therefore results in the support wing 26 having an overall C-shape which is substantially similar to that of the contacting surfaces. The length and width of support wing 26, according to this embodiment, may vary according to the amount of structural support which is required as determined by those having skill in the art. Variations of such dimensions as the length and width of support wing 26 may include a tapered design in which the width of support wing 26 gradually increases or decreases about the length of any of the respective surfaces. Another variation may include a support wing 26 which is of a constant width. Further variations may include invariable shifts in the width or length of the support wing 26.

According to another embodiment of the present invention, the support wing 26 is composed of more than one independent structures emanating from the reverse side of the contact surfaces. Such independent structures may or may not follow the contour of the surfaces. The independent structures may further be connected to one another so as to form a substantially similar design to that of the previous embodiment in which the support wing 26 consisted of a singular structure.

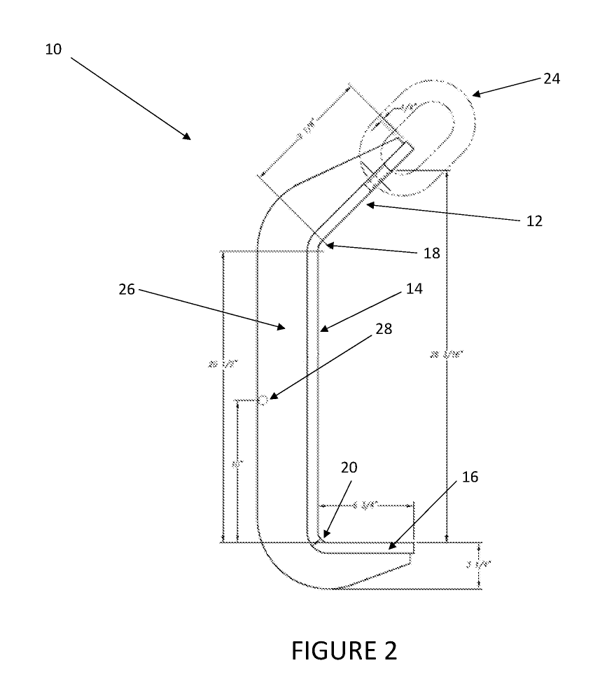

With reference now to FIG. 2, the relative dimensions of the plate lifting hook 10 may be seen. According to one embodiment, the length of the connecting surface 12 is approximately 9⅛″. The approximate length of the backing surface 14 is 20½″, and the approximate length of the supporting surface is 6¾″. Various other similar embodiments may be used which use similar proportions of length as expressed in the present embodiment. Accordingly, the backing surface 14 is the longest of the 3 surfaces. The backing surface 12 is approximately one half of the length of the backing surface 14. The supporting surface 16 is approximately one third of the length of the backing surface 14.

The aforementioned lengths of the respective surfaces are but one embodiment of the present invention. Each of the connecting surface 12, backing surface 14, and supporting surface 16 may be of varying lengths so long as each respective surface retains the capability of performing its desired function as identified by those having skill in the art. Further embodiments of the plate lifting hook 10 may include a connecting surface 12 and supporting surface 16 which are of substantially the same length. A further embodiment may use three surfaces which are all of substantially the same length.

With continued reference to FIG. 2, the relative position of support wing 26 in relation to that of the contact surfaces 12, 14 and 16 may be fixed. According to one embodiment, support wing 26 is positioned such that it is recessed approximately ¼″ inside the boundary face of each of the backing surface 12 and supporting surface 16. Support wing 26 then begins to taper away from the contact surfaces as it extends away from each of the respective boundary edges of the backing surface 12 and supporting surface 16. As the tapering of support wing 26 reaches each of the respective first and second angles 18 and 20 at which each of the backing surface 12 and supporting surface 16 transition into the backing surface 14, support wing 26 reaches a relative maximum width with respect to either the connecting surface 12 or supporting surface 16 of approximately 3¼″, as measured from the inside contacting surface of either connecting surface 12 or supporting surface 16. This relative maximum width of support wing 26 with relation to either connecting surface 12 or supporting surface 16 may thus be maintained about the entire length of the backing surface 14, or extrude further away from that of the contact face of backing surface 14.

According to further embodiments, support wing 26 may be alternatively positioned about each of the contact surfaces 12, 14, and 16. By way of one example, support wing 26 may be placed flush against either one of, or both of, the boundary edge of the connecting surface 12 and supporting surface 16. According to a further embodiment, support wing 26 may be recessed at a position further away from the respective boundary edges of either, or both, of the connecting surface 12 and supporting surface 16.

According to yet another embodiment, the tapering nature of support wing 26 may follow another pattern. Such a tapering may extrude outward from the contact surfaces such that the overall width of support wing 26, when measured at its largest value, is either more or less than that of approximately 3¼″, as measured from the inside contacting face of either connecting surface 12 or supporting surface 16. Yet another embodiment may taper in such a manner that the thickest portion of support wing 26 is located immediately adjacent to that of either, or both of, the connecting surface 12 or supporting surface 16. Still a further embodiment may incorporate support wing 26 which does not taper as it extends about the length of the respective contact surfaces, but rather exhibits a constant overall width.

With continued reference to FIG. 2, a handle 28 or other similar gripping utensil may be located about the length of support wing 26. The handle 28 may be positioned such that it is located at a distance of about one half the length of the backing surface 14. According to an embodiment of the plate lifting hook 10 wherein the length of the backing surface 14 is approximately 20½″ in length, the handle 28 is positioned approximately 10″ upward from the bottom portion of the backing surface 14, or that end of the plate lifting hook 10 which is either attached to, or transitions into about a second angle 20, the supporting surface 16.

Still in reference to FIG. 2, the relative position of the channel 28 may be approximated with reference to that of the supporting surface 16. The outermost edge of channel 28, or that edge which is closest in proximity to that of the boundary edge of the connecting surface 12, may be positioned at a distance of approximately 26 3/16″ from that of the inner contact face of the supporting surface 16.

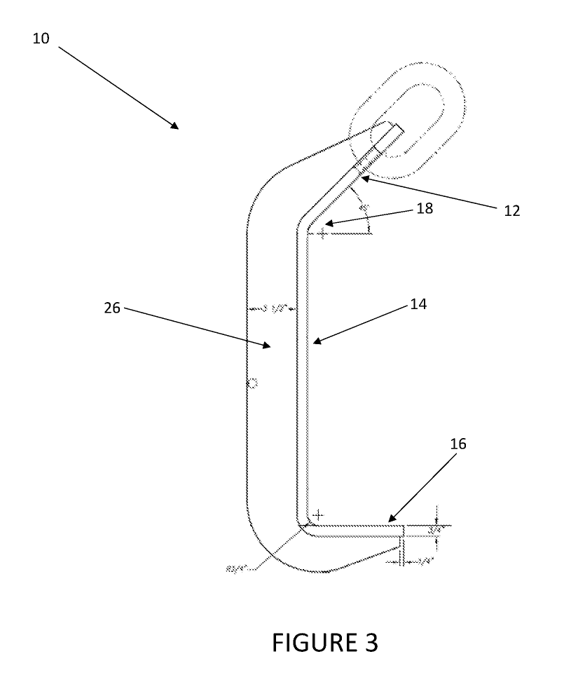

With reference now to FIG. 3, the relative elevation of the first angle 18, as measured from a point of reference which is perpendicular to that of the backing surface 14, may be approximately 45°. Thus, the first angle 18 causes the connecting surface 12 to extend in an upward manner away from that of the supporting surface 16.

With continued reference to FIG. 3, according to one embodiment, support wing 26 may reach an absolute maximum thickness of approximately 3½″. Such a maximum thickness may be located about the length of the backing surface 14. Support wing 26 may exhibit a generally consistent thickness about the length of backing surface 14, or may exhibit numerous variations in the thickness thereof about the length of backing surface 14.

With continued reference to FIG. 3, the width of each of the contact surfaces may be approximately ¾″. Such a thickness may be measured from the boundary edge of either the connecting surface 12 or supporting surface 16. This thickness may be relatively consistent about the length of the respective surfaces, exhibiting some minor variations therefrom at the points where each of the respective surfaces transitions into that of the backing surface 14 at either of the first or second angles, 18, 20.

According to another embodiment, the width of each of the respective contact surfaces may vary. By way of one example, the width of the connecting surface 12 may be greater or less than that of either the backing surface 14 or supporting surface 16. Additional variations in the thickness of the respective contact surfaces are possible without departing form the scope of the present disclosure.

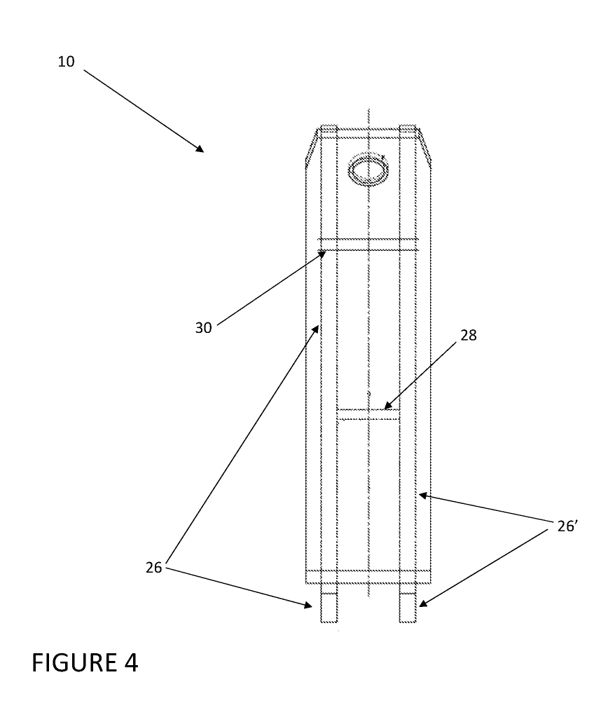

With reference now to FIG. 4, the plate lifting hook 10 may be viewed from the backside. From this perspective, support wing 26 is able to be seen as it runs along the contour of the contact surfaces, which are now oriented away from the perspective of viewing. Support wing 26 may thus have a congruent and equal additional secondary feature of structural support, support wing 26′, which is defined by substantially the same limitations and dimensions as that of support wing 26. According to this embodiment, each of support wing 26 and support wing 26′ share the same physical properties as discussed in the previous embodiments. Support wings 26 and 26′ therefore run parallel to one another and provide the similar benefits of structural support to plate lifting hook 10.

With continued reference to FIG. 4, at least one supporting rib 30 may be seen. Supporting rib 30 runs perpendicular to that of support wings 26 and 26′. Supporting rib 30 may thus be affixed to each of support wings 26 and 26′ by any means which is capable of providing supporting rib 30 with an adequate level of structural support as recognized by those skilled in the art. Supporting rib 30 may be manufactured from any material capable of providing plate lifting hook 10 with the proper amount of structural support. Accordingly, the materials which are used to construct support wings 26 and 26′ are thus sufficiently capable of being used for the manufacture of supporting rib 30. Various embodiments of the present invention may include any number of additional supporting ribs, in addition to that of supporting rib 30, so as to increase the structural support of the plate lifting hook 10.

In a similar manner to that of supporting rib 30, the handle 28 may also be affixed so as to bridge the gap between support wings 26 and 26′. Similarly to that of supporting rib 30, the handle 28 may also be manufactured of those materials which are capable of satisfying the structural requirements of support wings 26 and 26′.

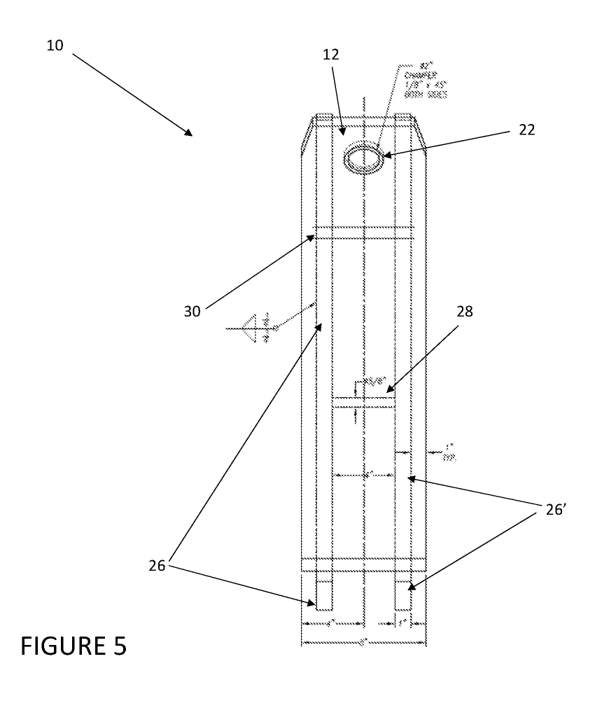

With reference now to FIG. 5, the placement of the support wings 26 and 26′, as well as the secondary features of structural support including supporting rib 30 and handle 28, may be according to various designs. According to one embodiment, the handle 28 may be substantially round, having a diameter which is approximately ⅝″. Such a dimension may further represent the diameter of supporting rib 30, as well as any additional secondary features of structural support, including but not limited to, additional supporting ribs.

According to further embodiments, supporting rib 30 and handle 28 may be of an alternative design such that each is not substantially round. By way of one example, either of supporting rib 30 or handle 28 may be substantially rectangular in nature. Such a structure may be similar to that of a cross-member or support bar which is defined by having distinct faces thereon, rather than generally smooth surfaces which are commonly associated with that of round or circular designs.

With continued reference to FIG. 5, each of support wings 26 and 26′ may be characterized by having an approximate width of 1″. According to such an embodiment, the approximate width of the plate lifting hook 10, when measured from the outer boundary of opposing sides, is 8″. Such a width of the plate lifting hook 10 may be divided, for visual purposes aiding in the construction and formulation thereof, about the center of the device, resulting in two equal portions, each having an approximate width of 4″. Each of support wing 26 and 26′ may thus be affixed within a respective portion of the plate lifting hook 10 such that the inner faces of the support wings are approximately 4″ apart from one another, when measured from the inner surface or face which is oriented towards the opposing support wing.

According to one embodiment, the placement of supporting rib 30 may be above the relative location of handle 28. The precise location may be specified by one having skill in the art so as to afford plate lifting hook 10 with an adequate amount of structural support. According to another embodiment, supporting rib 30 may be placed below the relative position of handle 28. The precise location may be specified by one having skill in the art so as to afford plate lifting hook 10 with an adequate amount of structural support. Further embodiments of the present invention may involve supporting ribs similar to that of supporting rib 30 which may be placed both above and below the relative position of handle 28. According to such embodiments, the number of additional supporting ribs placed both above and below the relative position of handle 28 may be chosen by those having skill in the art.

With continued reference to FIG. 5, the channel 22 may be substantially circular. According to one embodiment, the channel 22 is located such that the center point of the substantially circular channel 22 is centered about the relative midpoint of the plate lifting hook 10, or approximately 4″ from either of the outer edges of the plate lifting hook 10. The channel 22 may be of a diameter which is identified by those having skill in the art as being suitable for use with lifting devices which are commonly used in the field of lifting plates.

Continuing with reference to FIG. 5, the channel 22 may be positioned on the face of connecting surface 12 at any location relative to the edges thereof which allows for channel 22 to retain the necessary level of support which allows the channel 22 to support the weight of the load which may be apportioned thereto. The edges of the channel 22 may be machined or textured such that they are more receptive of the corresponding means of an external lifting component where are to be inserted, affixed, or otherwise attached thereto. Such an embodiment may be by way of chamfered or beveled outer edges, or any other means identified by those skilled in the art. The presence of such edges surrounding and further defining channel 22 may further be characterized by allowing for the channel 22 to receive alternative means of attachment. Such alternative means of attachment may include insertions or other like devices which allow for the effective area of the channel 22 to be altered in accordance with that of the size of the corresponding means of the external lifting component which is to be inserted therein.

According to one embodiment, the size of channel 22 is chosen such that it corresponds to that of the largest corresponding component of an external lifting device which is commonly used for such related tasks. The channel 22 is thus capable of receiving different devices which allow for a relative reduction in the effective area of channel 22.

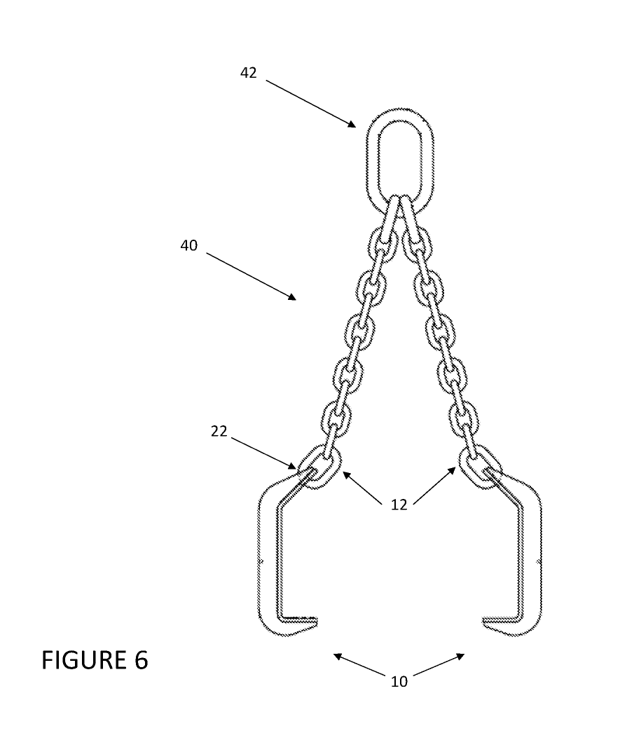

With reference now to FIG. 6, the plate lifting hook 10 may be affixed to a corresponding component of an external lifting device, such as a chain sling 40. The chain sling 40 is but one example of a corresponding component which is commonly used in the field of lifting plates. According to such an embodiment, a component of the chain sling 40 is inserted through channel 22 such that the plate lifting hook 10 is suspended therefrom. The plate lifting hook 10 is thus capable of being manipulated by a user which is in control of the external lifting device.

With continued reference to FIG. 6, an embodiment is shown in which multiple plate lifting hooks are capable of being affixed to a single external lifting device. According to this embodiment, multiple chain slings, or other corresponding components of the external lifting device, may originate from a single location, such as ring 42. Any combination of corresponding components may be used which allows for the attachment of plate lifting hooks thereto as is identified by those having skill in the art.

As described above, the present disclosure has been described with preferred embodiments thereof and it is understood that many changes and modifications to the described embodiments can be carried out without departing from the scope and the spirit of the present disclosure that is intended to be limited only by the appended claims.

Having thus described the invention, it is now claimed:

1. A device comprising:
a first surface, said first surface further comprising;
at least one channel, wherein said channel is capable of receiving a means of attachment;
a second surface;
a third surface;
at least one support wing, and;
at least one support rib
wherein the inner face of each of said first surface, second surface, and third surface are capable of contacting a load to be transported by said device, the structural relationship between said first surface, second surface, and third surface is defined by said first and third surfaces being affixed to said second surface and extending outward therefrom in the same general direction such that said first and third surfaces are not characterized as lying in the same directional vector as that of the second surface, said at least one support wing is defined by extruding away from that of the contact face of each of said first surface, second surface, and third surface, while additionally following the same general contour of said first surface, second surface, and third surface, and said at least one support rib is oriented substantially perpendicular to that of the at least one support wing along those portions thereof which run along the contour of said second surface.

2. A method of fabricating a lifting hook, comprising:
forming the contact surfaces of the hook by way of a cold forming process, wherein said contact surfaces are further comprised of a lower alloy material;
forming a supporting structure from a high strength material, and;
affixing said supporting structure to said contact surfaces by way of welding, wherein said contact surfaces of the lifting hook are not subjected to any further heat treatment which would alter the physical properties thereof.
